(19) United States
(12) Patent Application Publication
(10) Pub. No.: US 2006/0241900 A1
(43) Pub. Date: Oct. 26, 2006

(54) Statistical data analysis tool

(76) Inventors: Qingmao Hu, Singapore (SG); Wieslaw L. Nowinski, Singapore (SG)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/530,973

(22) PCT Filed: Oct. 11, 2002
(86) PCT No.: PCT/SG02/00231

§ 371 Date: May 2, 2006

(51) Int. Cl. G06F 19/00

(52) U.S. Cl. 702/179

(57) ABSTRACT

A functional model for a set of experimental data has K independent parameters. The parameters are to be estimated from an experimental data-set of N data points, comprising “inlier” data points representative of the model and “outlier” data points which are not representative of the model. Multiple subsets of the data points are defined, and each used to estimate the parameters of the model. The various estimates of the parameters are plotted in the parameter space to identify the peak parameters in the parameter space. Data points which are not described by the model using the said peak parameters are judged to be outliers. The method makes it possible to identify up to N−K′−3 outliers (K′ is the minimum number of data points through any subset of the input data set the K parameters of the model can be uniquely calculated).

### FIELD OF THE INVENTION

The present invention relates to methods and apparatus for analysing an experimental data-set to estimate properties of the distribution (“model”). In particular, it relates to methods and apparatus in which a model of known functional form is estimated from the experimental data-set.

### BACKGROUND OF INVENTION

Many data-sets can be regarded as made up of (i) data points obtained from and representative of a model (“inliers”) and (ii) data points which contain no information about the model and which therefore should be neglected when parameter(s) of the model are to be estimated (“outliers”).

Existing outlier removal methods operate by using all the data points to generate one or more statistical measures of the entire data-set (e.g. its mean, median or standard deviation), and then using these measures to identify outliers. For example, the “robust standard deviation algorithm” (employed in [1]) computes a median and a statistical deviation from a number of data values and then discards as outliers all data points which are further than 3 standard deviations from the median. The “least median of squares algorithm” (employed in [2] and [3]) is applicable to data-sets composed of points in a two-dimensional space, and calculates the narrowest strip bounded by two parallel lines which contains the majority of the data points; again, once this strip has been determined using the entire data-set, the outliers are discarded. The “least trimmed squares algorithm” (employed in [4]) consists of minimising a cost function formed from all the data points, and then discarding outliers determined using the results of the minimisation. All three of these methods have the problem that they fail to work if the proportion of the outliers is greater than 50% of the data-set, because in this case the statistical measure of the entire data-set will be largely determined by the outliers, so that the points discarded as “outliers” will in fact include an approximately equal proportion of inliers.

Mathematical methods are used in the digital signal processing field to characterise signals and the processes that generate them. In this field outlier is called noisy signal. A primary use of analogue and digital signal processing is to reduce noise and other undesirable components in acquired data.

In psychology, researchers usually find the basis for predicting behaviour and studying a particular phenomenon and individual reactions to it. Outliers are individuals with abnormal reaction. To generate a model for the majority one should eliminate objects with uncommon response, that is, the outliers. In general, researchers in this domain use all sets of statistical methods: regression, correlation, factors, and cluster analysis. To avoid abnormal individuals some usual and specific approaches are applied in psychology, some of them are threshold values, confident intervals, normal distribution assumption, clustering, and pattern-based.

In the pharmaceutical field, researchers confront a lot of outliers and aberrant observations. As usual, least-square procedures are applied very often. Some other methods like Q test or Dixon's test are used for outlier removal as well [6].

Outlier removal is especially important in medical imaging, where outliers generally correspond to abnormalities or pathologies of subjects being imaged. An efficient way to remove outlier is desirable to enhance the capability of dealing with both normal and abnormal images.

### SUMMARY OF THE INVENTION

The present invention aims to address the above problem. In particular, the invention makes it possible to judge which data points are outliers by applying criteria different from statistical measures determined by the whole data-set.

In general terms, the present invention proposes that multiple subsets of the data points are each used to estimate the parameters of the model, that the various estimates of the parameters are plotted in the parameter space to identify peak parameters in the parameter space, and the outliers are identified as data points which are not well-described by the peak parameters. In the original data space the data will scatter due to various reasons. When these input data are converted into parameter space, parameters corresponding to correlated features tend to form dense clusters. That is why parameter space is preferred to remove outliers.

Generally, for a model determined by K parameters, each subset should contain at least K′ data points to enable the K parameters to be estimated. K′ is the number that will uniquely determine the K parameters of a subset of data points containing K′ data points arbitrarily picked out from the N input data points.

Note that the subsets comprising only inliers will most likely form one cluster—being correlated with each other in the parameter space—whereas the subsets containing one or more outliers will tend to be less correlated. This result is true irrespective of the proportion of outliers in the data-set, and thus the present invention may make it possible to accurately discard a number of outliers which is more (even much more) than half of the data points. As explained below, some embodiments of the method are typically able to remove (N−K′−3) outliers from an input data-set with N data points.

### BRIEF DESCRIPTION OF THE FIGURES

Preferred features of the invention will now be described, for the sake of illustration only, with reference to the following figures in which:

FIG. 1 shows the steps of a method which is an embodiment of the invention.

FIG. 2 shows the steps to derive a plane equation of the midsagittal plane (MSP) from 16 extracted fissure line segments by an embodiment of the invention.

FIG. 3 illustrates steps to approximate a plane equation of the MSP from orientation inliers by an embodiment of the invention.

FIG. 4 shows the results of approximated orientation by an embodiment of the invention and the method proposed by Liu et al [1]. The bold line represents the estimated orientation based on the embodiment while the dashed bold line represents the estimation derived from Liu et al [1].

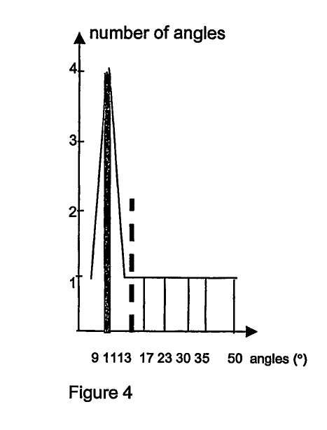

### DETAILED DESCRIPTION OF THE EMBODIMENTS

Suppose the experimental data-set comprises N input data points. Each input data point is any quantity or vector denoted as X, X can be a vector of coordinates, gray level related quantities if the data originates from images, etc. X is called the feature vector of the input data point.

In the embodiment, the model has K independent parameters pⱼ(j=1, . . . ,K) and is usually a function of X. The model is denoted as mod(X) given by:
mod(X)=p₁.base₁+p₂.base₂+ . . . + pₖ.baseₖ (1)
where baseⱼ (j=1, . . . K) are known functions of the feature vector, X and the symbol “.” represents multiplication. A determination of the model is thus equivalent to the task of identifying the K parameters p₁, . . . , p_{K} using the experimental data-set.

For each data point with feature vector Xᵢ, a corresponding model value mod(Xᵢ) can be calculated, where i=1, . . . , N. For inlier data points, Xᵢ and mod(Xᵢ) are related by equation (1), possibly with a noise, whereas outlier data points are not related by equation (1).

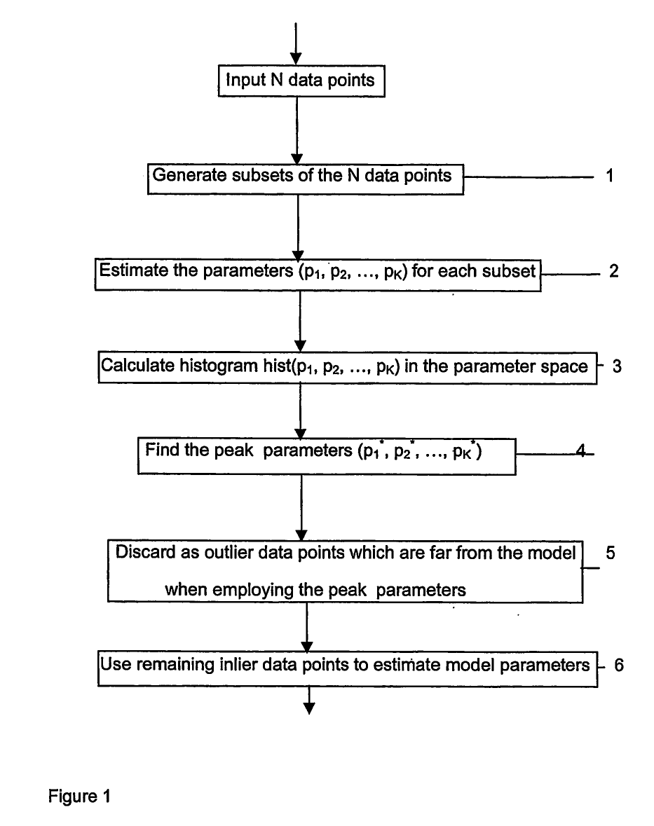

The method proceeds by the steps shown in FIG. 1.

In step 1 a number of subsets of the input data-set is generated. Each subset is composed of at least K′ (K′ is the number by which the K parameters will be uniquely determined in the subset containing any K′ data points) of the N input data points. The number of subsets with K′ data points which can be formed in this way is C_{N}^{K′}=(N.(N−1).(N−2) . . . 2)/(K′.(K′−1).(K′−2). . . 2). Note that in some applications all of these subsets may be generated, while in other applications only a portion of the total number of subsets may be generated. Denote the total number of ways to form the subsets as M.

In step 2, for each of the subsets the parameters {p₁, . . . , pₖ} are estimated either by least square mean estimation or by solving the K′ linear equations. Thus, each subset yields a respective point in the K-dimensional parameter space. Hence in the K-dimensional parameter space, M parameter points are obtained from the estimation, with each parameter point denoted Pᵢ=(p₁(i), p₂(i), . . . , p_{K}(i))^{T}. Here T stands for transpose. Each subset of input data points will have a corresponding parameter point in the parameter space.

In step 3, count the number of occurrence of a parameter point (histogram), and plot the histogram in the parameter space to show, for each of the M parameter points, the number of subsets of input data points with the parameters close to the parameter point. For some applications, the parameters may need to be digitised with any digitisation method (for example, an orientation of both 1.0° and 1.02° may both be digitised to 1.0°). As the parameters derived from each subset of input data points will be distributed in the K-dimensional parameter space, a preferable way to get the histogram from the distribution is to specify the sizes of neighborhood in each coordinate of the parameter space. The neighborhood sizes can be specified by users or by any means. Below a way to calculate the neighborhood sizes is illustrated. For the j-th (j=1, 2, . . . , K) coordinate of all the M parameter points of the estimated parameters, arrange them in ascending order and still denote them as pⱼ(1), pⱼ(2), . . . , pⱼ(M) for simplicity of denotation. The difference between pⱼ(t+1) and pⱼ(t) (t=1, 2, . . . , M−1) is denoted dif(pⱼ, t). The neighborhood size for the jth coordinate can be the median of dif(pⱼ, t) for all t ranging from 0 to M−1, or the average of dif(pⱼ, t), or any percent of the distribution of dif(pⱼ, t) (100 percent will correspond to the maximum of dif(pⱼ, t) while 0 percent will be 0, and 10 percent corresponds to the neighborhood size so that the number of difference dif(pⱼ, t) being smaller than the neighborhood size will be no more than 0.1*(M−1)). Having decided the neighborhood size for each coordinate of the parameters, namely, the j-th coordinate's neighborhood size being Δⱼ, the number of points for a given parameter point Pᵢ (i=1, 2, . . . , M) in the parameter space is the number of parameter points P=(p₁, p₂, . . . pₖ)^{T} falling in the neighborhood

|p₁−p₁(i)|≦Δ₁, |p₂−p₂(i)|≦Δ₂, . . . , |p_{K}−p_{K}(i)|≦Δ_{K}

This number of points is also called the number of occurrence of the subsets of input data with the parameters specified by the parameter point Pᵢ.

In step 4, we find the peak of the histograms found in step 3. The K parameters corresponding to the peak of the histogram are called candidate peak parameters. If the number of occurrence of the histogram peak is greater than a predetermined threshold, e.g. 3, and there is only one peak, then we may take the peak as a good estimate of the true parameters of the model, and the candidate peak parameters are called peak parameters. Note that such a peak will generally be found when at least 3 of the subsets consists exclusively of inlier data points. This is bound to occur when there are at least K′+3 inliers (so that at least 3 subsets are composed entirely of inliers), and thus the present method can cope even in the case that there are N−K′−3 outliers. In the case of multiple peaks exhibited in the histogram, depending on the nature of the original problem, one way is to take the candidate peak parameters with the maximum number of occurrence as the peak parameters. Alternatively, one can pick up the candidate peak parameters with the maximum integration as the peak parameters.

In step 5 we determine which input data points are such that they follow equation (1) with parameters equal to or very close to the peak parameters. Such input points are judged to be inlier input data points. All other input points are judged to be outlier input points.

In step 6 we determine a best estimate for the parameters using only the inliers. This can be done by a conventional method, such as a least square fit of the inliers.

We now consider one specific example of the method, namely to derive the midsagittal plane (MSP) from magnetic resonance (MR) brain images. Determination of midsagittal plane of the human brain is
1) a prerequisite for Talairach framework [7];
2) the first step in spatial normalisation or anatomical standardisation of brain images;
3) a first step in intra-subject, inter/intra-modality image registration;
4) helpful to detection of brain asymmetry due to tumors as well as any mass effects for diagnosis.

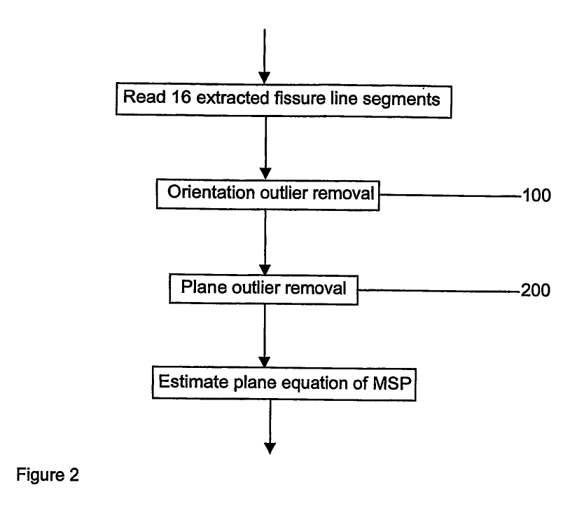

According to the patent application [5] entitled “Method and apparatus for determining symmetry in 2D and 3D images” (International application number PCT/SG 02/00006), around 16 fissure line segments are extracted from 16 parallel planes of the volume (axial slices). Due to the pathology or ubiquitous asymmetry presented in axial slices, some of the extracted fissure line segments deviate greatly from the expected fissure that should be removed in order to get a precise plane equation of the MSP. There are two kinds of outliers to remove, i.e., orientation outliers and plane outliers. As all extracted fissure line segments are from different parallel axial slices and they are supposed to form a plane (the MSP), they should have the same orientation. Those extracted fissure line segments deviating from the expected orientation are taken as orientation outliers and the rest of extracted fissure line segments as orientation inliers. For all the orientation inliers, some extracted fissure line segments may deviate from an expected plane, and are judged as plane outliers with the rest of orientation inliers judged as plane inliers. The plane equation of the MSP is calculated by the least square error fit of all the plane inliers. Both the expected orientation and expected plane are derived from the proposed invention described below. FIG. 2 shows the steps to derive plane equation of the MSP from the 16 extracted fissure line segments. In step 100, orientation outliers are removed. In step 200, plane outliers are removed. Following this the plane equation of the MSP is estimated.

For orientation outlier removal, the model is a constant, i.e.,

mod (X)=1

Reference [5] includes a detailed description of the orientation outlier removal, but reference [5] can only deal with the orientation outlier removal based on empirical trial instead of a systematic framework while the current invention tends to provide a solution for the outlier removal of all kinds of models. For removal of plane outliers, the model is a three-dimensional plane, i.e.,

Mod(X)=p₁.x+p_{2.}y+p_{3.}z+p₄

where (x, y, z) are the coordinates in the three-dimensional image volume. In order to facilitate histogramming, it is supposed that

p₁²+p₂²+p₃²=1, p₄>=0.

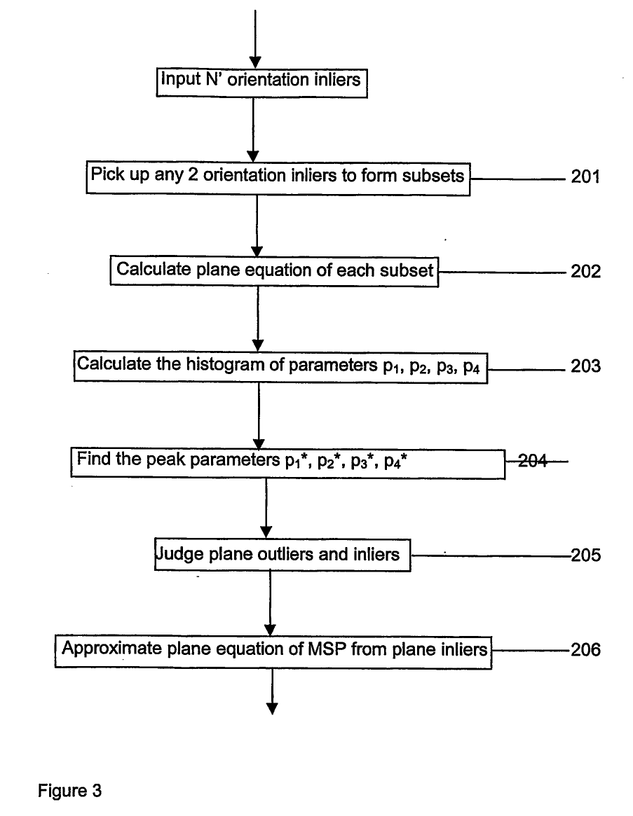

There are 3 independent parameters for the model. Each subset of data will contain two orientation inliers (4 three-dimensional points in three-dimensional image volume). Suppose there are N′ (N′<=16) orientation inliers. Refer to FIG. 3 for the steps to remove plane outliers and to calculate the plane equation of the MSP:
1) From N′ orientation inliers pick up any 2 orientations to form all the subsets (step 201). There are altogether N′ (N′−1)/2 different subsets.
2) Calculate the least square fit plane equation of each subset (step 202);
3) Calculate the histogram of p₁, p₂, p₃ and p₄ by specifying the neighborhood sizes of p₁ being 0.1, p₂ 0.1, p₃ 0.1, and p₄ 1.0 (step 203);
4) Find the maximum peak of the histogram (step 204) and denote the parameters corresponding to this peak as p₁*, p₂*, p₃*, and p₄*
5) Judge those subsets as outlier subsets if their plane parameters (p₁, p₂, p₃, p₄) satisfying at least one of the following inequalities:
   |p₁−p₁*|>0.1, |p₂−p₂*|>0.1, |p₃−p₃*|>0.1, |p₄−p₄*|>1.0
   The rest of the subsets are considered inlier subsets. Those orientation inliers included in any of the inlier subset are judged as plane inliers. The rest of the orientation inliers are judged as plane outliers (step 205).
6) Finally the plane equation of the MSP is the least square fit of the plane inliers (step 206).

Efficient outlier removal is a key factor to deal with both normal and pathological images in medical imaging. In the case of extraction of the MSP, the method proposed by Liu et al [1] uses the robust standard deviation, but still the inliers may have a scattered orientation instead of the dominant one which corresponds to the maximum peak of the histogram. The next example will illustrate this. The method proposed by Prima et al [4] uses the least trimmed squares estimation which can tackle at most 50% of outliers while the embodiment can yield an outlier removal rate (3 plane inliers—13 plane outliers out of 16 data) 81%.

Note that in this example, it is supposed that at least 3 strongly correlated subsets are available when at least K′+3 (K′=1) inliers are present (the occurrence of the peak orientation will be no less than 3). In other words, the present method can function satisfactorily even when there are N−K′−3 outliers.

In the next example, the difference between the embodiment of this invention and the result based on robust standard deviation as used by Liu et al [1] is illustrated.

Suppose the orientations of 11 extracted fissure line segments are 50°, 35°, 30°, 23°, 17°, 13°, 11°, 11°, 11°, 11°, 9° respectively. The median of the angle is 13°, and the robust standard deviation is 4.45°. According to [1], only three angles (50°, 35°, 30°) will be judged as outliers. The weighted estimation of orientation will be 15.8°, and the average of the inlier orientation is 13.25°. By the method disclosed in this invention, the peak parameter of the orientation is 11° by specifying the neighborhood size being 1°, which is the dominant orientation. Note the number of outliers is 6 which is beyond the limit of existing outlier removal methods, so it is understandable the existing methods will not able to remove all the outliers. The embodiment takes 11° as the inliers from the histogram and the number of outliers is 7.

### REFERENCES

The disclosure of the following references is incorporated herein in its entirety:
[1] Liu Y, Collins R. T. and Rothfus W. E., “Robust Midsagittal Plane Extraction from Normal and Pathological 3-D Neuroradiology Images,” 2001, IEEE Transactions on Medical Imaging, 20(3), p173-192.
[2] Zhang G., Umasuthan M., and Wallace A. M., “Efficient outlier removal algorithm,” 1993, Nonlinear Image Processing IV (Dougherty E. R., Astola J., Longbotham H. G eds), p77-87.
[3] Bab-Hadiashar A., Suter D., “Motion Estimation using robust statistics”, 1996, Technical Report MECSE-96-4, Monash University, Clayton 3168, Australia.
[4] Prima S., Ourselin S., Ayache N., “Computation of the midsaggital plane in 3D brain images”, 2002, IEEE Transactions on Medical Imaging 21(2), p122-138.
[5] Hu Qingmao, Nowinski Wieslaw, “Method and apparatus for determining symmetry in 2D and 3D images,” International Patent Application no. PCT/SG 02/00006.
[6] Hadjiioannou T. P. et al., “Quantitative calculations in pharmaceutical practice and research”, 1993, VCH Publisher Inc.
[7] Lancaster J L, Glass T G, Lankipalli B R, Downs H, Mayberg H, Fox P T. “A modality-independent approach to spatial normalization of tomographic images of the human brain,” 1995, Human Brain Mapping; 3: 209-223.

1. A method of processing an experimental data-set comprising inlier data points representative of a model and outlier data points which are not representative of the model, to identify which of the data points are the said outlier data points, the model being a predetermined function of K unknown parameters, the method comprising:
generating a plurality of subsets of the data points, each subset comprising at least K′ data points, where K′ is the number of data points which will uniquely determine the K parameters;
for each subset estimating the K parameters of the model;
identifying at least one location in the parameters space at which the estimates are clustered; and
identifying as said outlier data points data points which are not representative of the model as defined based on peak parameter values corresponding to said location.

2. A method according to claim 1 in which each of the subsets comprises exactly said K′ or more than said K′ data points.

3. A method according to claim 2 in which all possible subsets with at least said K′ points are generated.

4. A method according to claim 1 in which the said peak parameters are identified based on histogram analysis, including the following steps:
1) generating all the possible said subsets from the N input data points, with each said subset having same number of data points and containing at least said K′ data points, the number of said subsets being denoted as M;
2) for each said subset, calculating the K parameters of the said subset as a respective point in the said K-dimensional parameter space;
3) plotting a histogram of the said parameter points;
4) finding the peaks of the said histogram and finding the said peak parameters (p₁*, p₂*, . . . , p_{K}*) from all the possible candidate peak parameters which are parameters corresponding to different histogram peaks.

5. A method according to claim 4 in which the said histogram in the said K-dimensional parameter space is obtained either by
1) a user specifying the neighborhood sizes in each coordinate of the said parameter points in the said K-dimensional parameter space, or
2) deriving the neighborhood sizes from the said M parameter points in the said K-dimensional parameter space automatically using said data points.

6. A method according to claim 4 in which:
1) if there is only one peak in the said histogram of the said parameter points and the said number of occurrence is not less than 3, all the said parameter points within the said neighborhood sizes of the said candidate peak parameters are taken as the said cluster location, and the sole candidate peak parameters are taken as the said peak parameters; and
2) if there are more than one peak in the said histogram of the said parameter points, either (i) the said parameter point with said maximum number of occurrence is taken as the said peak parameters and all those said parameter points within the said neighborhood sizes of the said peak parameters are taken as the said cluster location, or (2) the said parameter point with maximum sum of said number of occurrence within a neighborhood are taken as the said peak parameters, and all those said parameter points within the said neighborhood sizes of the said peak parameters are taken as the said cluster location.

7. A method according to claim 1 in which said data points are categorised as said outlier data points by:
1) identifying those said subsets with the said parameter point Pᵢ being close to the said peak parameters as inlier subsets, according to whether Pᵢ satisfies the following inequalities simultaneously

|p₁*−p₁(i)|<=Δ₁, |p₂*−p₂(i)|<=Δ₂, . . . , |p_{K}−p_{K}(i)|<=Δ; and
2) identifying any said data point contained in any of the said inlier subsets as an inlier data point and identifying the rest of said N input data points as outlier data points.

8. A method of estimating a model from a data-set comprising the said inlier data points representative of the model and the said outlier data points which are not representative of the model, the method comprising processing the data-set using a method according to claim 1, and then estimating the K parameters of the model using the identified said inlier data points.

9. An apparatus for determining, among an experimental data-set comprising the said inlier data points representative of a model and the said outlier data points which are not representative of the model, the model being defined by K parameters where K is a positive integer, the apparatus comprising a processor arranged to perform the steps of:
generating a plurality of subsets of the data points, each subset comprising at least K′ data points;
for each subset estimating the K parameters of the model;
identifying at least one location in the parameters space at which the estimates are clustered; and
identifying as said outlier data points which are not representative of the model as defined based on peak parameter values corresponding to said location.

10. An apparatus according to claim 9 in which said processor is arranged to generate said subsets as subsets which each comprise at least K′ data points.

11. An apparatus according to claim 9 in which said processor is arranged to generate all possible subsets each with at least K′ data points.

12. An apparatus according to claim 9, further comprising means for estimating the parameters of the model using the identified said inlier data points.
